(19) United States
(12) Patent Application Publication
(10) Pub. No.: US 2004/0249782 A1
(43) Pub. Date: Dec. 9, 2004

(54) Method and system for highly efficient database bitmap index processing

(75) Inventor: Derek Orzo Ricci, Las Flores, CA (US)

Correspondence Address: SANDRA M. PARKER, ESQ., LAW OFFICE OF SANDRA M. PARKER, 329 La Jolla Avenue, LONG BEACH, CA, 90803, US

(73) Assignee: International Business Machines Corporation

(21) Appl. No.: 10/454,274

(22) Filed: Jun. 4, 2003

(51) Int. Cl. G06F 7/00

(52) U.S. Cl. 707/1

(57) ABSTRACT

A computer-based method for database bitmap index processing in a database management system. The method utilizes a microprocessor supporting instructions for simultaneous processing of at least 128 bits and having storage units of at least 128 bits to process bitmap index format database structures. The instructions may belong to the microprocessor's multimedia application extension and be in assembly language. One instruction moves content of the entire storage unit of at least 128 bits between a memory and a register, and another instruction performs a logical AND instruction on the two storage units of at least 128 bits. A join operation on two bitmap indexes is performed by comparing two bitmap indexes and computing their intersection using a logical AND instruction.

### BACKGROUND OF THE INVENTION

1. Field of the Invention

This invention relates in general to database management systems performed by computers, and in particular to a method and system for highly efficient database bitmap index processing.

2. Description of Related Art

Databases are computerized information storage and retrieval systems. A Relational Database Management System (RDBMS) is a database management system (DBMS) which uses relational techniques for storing and retrieving data. RDBMS software using a Structured Query Language (SQL) interface is well known in the art. The SQL interface has evolved into a standard language for RDBMS software and has been adopted as such by both the American National Standards Organization (ANSI) and the International Standards Organization (ISO).

A typical database management system includes both database files and index files. The database files store data in the rows and columns of tables stored on data pages. In such a table, the rows may correspond to individual records while the columns of the table represent attributes of the records. For example, in a customer information table of a database management system, each row might represent a different customer while each column represents different attributes of the customers, such as the name of each customer, the amount owed by each customer and the cash receipts received from each customer.

Instead of providing for direct sorting and searching of the records in the tables, the database management system relies on the index files which contain information or pointers about the location of the records in the tables stored in the database files. The index file can be searched and sorted (scanned) much more rapidly than can the database files. An index file is scanned through transactions in which criteria are stipulated for selecting records from a table. These criteria include keys which are the attributes by which the database finds the desired record or records using the index. The actions of a transaction that cause changes to recoverable data objects are recorded in a log.

In database management systems all data are stored in tables on a set of data pages that are separate from the index file. A table can have one or more indexes defined on it, each of which is an ordering of keys of the row of the tables and is used to access certain rows when the keys are known. An index is often implemented with a tree structure consisting of leaf pages and non-leaf pages. A page is a physical unit of transfer between main storage and secondary storage. A non-leaf page contains a list of page numbers of other index pages, along with the high key values for those pages. A leaf page is the lowest level of the index tree. It consists of keys and their associated row addresses which are pointers to the rows in the table that have the given key value.

Many modern relational database management systems include the capability to use bitmap indexes as an index format, in addition to the more traditional b+tree index format. In certain situations, the bitmap index has advantages over the b+tree index. This is especially true for data warehouse environments where many low cardinality columns must be indexes in many combinations. Because the bitmap index capability is generally understood to be valuable to customers, many major RDBMS vendors have included this functionality within their products. In current database technology, bitmap index processing uses a significant amount of computing resources, such as CPU time and memory bandwidth.

Therefore, there is a need for a simple, optimized and generic method and system for improving the efficiency of the bitmap index processing, thus reducing computer workloads and contributing to faster database queries and faster index tree traversals in database management systems.

### SUMMARY OF THE INVENTION

The foregoing and other objects, features, and advantages of the present invention will be apparent from the following detailed description of the preferred embodiments, which makes reference to several drawing figures.

One preferred embodiment of the present invention is a computer-based method for database bitmap index processing in a database management system. The method utilizes a microprocessor supporting instructions for simultaneous processing of at least 128 bits and having storage units of at least 128 bits to process bitmap index format database structures. The instructions may belong to the microprocessor's multimedia application extension and be in assembly language. One instruction moves content of the entire storage unit of at least 128 bits between a memory and a register, and another instruction performs a logical AND instruction on the two storage units of at least 128 bits. A join operation on two bitmap indexes is performed by comparing two bitmap indexes and computing their intersection using a logical AND instruction.

Another preferred embodiment of the present invention is a system implementing the above-mentioned method embodiments of the present invention.

Yet another preferred embodiment of the present invention includes a computer usable medium tangibly embodying a program of instructions executable by the computer to perform method steps of the above-mentioned method embodiments of the present invention.

### BRIEF DESCRIPTION OF THE DRAWINGS

Referring now to the drawings in which like reference numbers represent corresponding parts throughout:

FIG. 1 illustrates a computer hardware and software environment enabling the method for database bitmap index processing, according to the preferred embodiments of the present invention;

FIG. 2 illustrates an example of C code for database bitmap index processing;

FIG. 3 illustrates an example of assembly code for database bitmap index processing; and

FIG. 4 illustrates the highly efficient method for database bitmap index processing, according to the preferred embodiments of the present invention.

### DETAILED DESCRIPTION OF THE PREFERRED EMBODIMENTS

In the following description of the preferred embodiments reference is made to the accompanying drawings, which form the part thereof, and in which are shown by way of illustration specific embodiments in which the invention may be practiced. It is to be understood that other embodiments may be utilized and structural and functional changes may be made without departing from the scope of the present invention.

The present invention discloses a system, a method and a computer usable medium embodying a program of instructions executable by a computer to perform the method of the present invention for highly efficient database bitmap index processing.

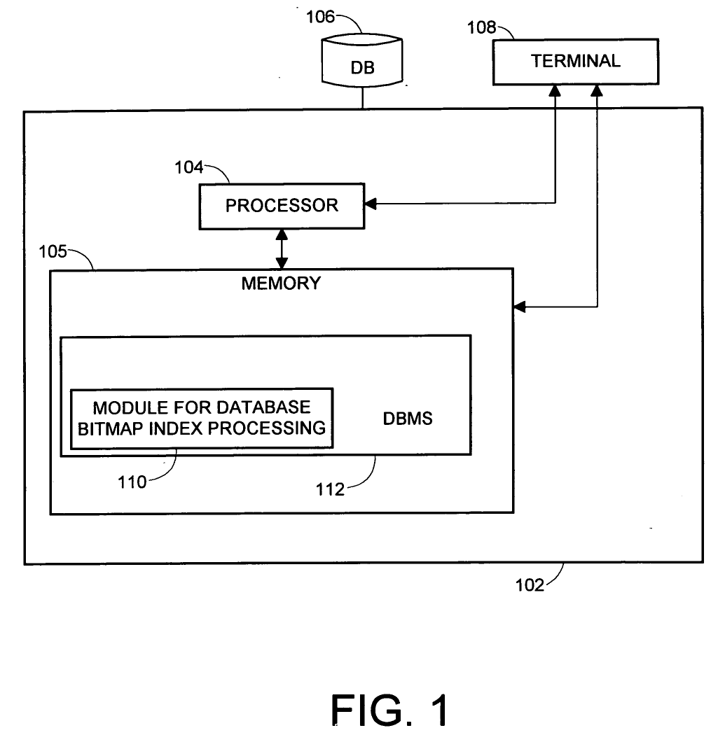

FIG. 1 illustrates an exemplary computer hardware and software environment usable by the preferred embodiments of the present invention, including a computer system 102 having one or more conventional processors 104 executing instructions stored in an associated computer memory 105, and having a computer system terminal 108. The operating memory 105 can be loaded with instructions received through an optional storage drive or through an interface with a computer network.

The processor 104 is connected to one or more electronic storage devices 106, such as disk drives, that store one or more relational databases. They may include, for example, optical disk drives, magnetic tapes and/or semiconductor memory. Each storage device permits receipt of a computer usable medium, such as a magnetic media diskette, magnetic tape, optical disk, semiconductor memory and other machine-readable storage device, and allows for method program steps recorded on the computer usable medium to be read and transferred into the computer memory. The recorded program instructions may include the code for the method embodiment of the present invention. Alternatively, the program steps can be received into the operating memory from a computer over the network.

Operators of the computer system terminal 108 use a standard operator terminal interface (not shown), such as IMS/DB/DC, CICS, TSO, OS/2, UNIX, Windows or other similar interface, to transmit electrical signals to and from the computer system 102, that represent commands for performing various tasks, such as search and retrieval functions, termed queries, against the databases stored on the electronic storage device 106. Data storage and retrieval is accomplished with queries against a database stored on an electronic storage device. In the present invention, these queries conform to the Structured Query Language (SQL) standard, and invoke functions performed by a DataBase Management System (DBMS) 112, such as a Relational DataBase Management System (RDBMS) software. In the preferred embodiments of the present invention, the RDBMS software is the DB2 product, offered by IBM for the z/OS, AS400, OS390, or OS/2 operating systems, the Microsoft Windows operating systems, or any of the UNIX-based operating systems supported by the DB2. Those skilled in the art will recognize, however, that the present invention has application to any RDBMS software that uses SQL, and may similarly be applied to non-SQL queries and to non-relational databases. The method and system of the present invention may be used in a distributed computing environment in which two or more computer systems are connected by a network, such as World Wide Web, including environments in which the networked computers are of different type.

FIG. 1 further illustrates a software environment enabling preferred embodiments of the present invention. In the system shown in FIG. 1 the computer system 102 further includes a software module for highly efficient database bitmap index format processing 110.

Many modern relational database management systems include the ability to use bitmap indexes as an index format for their columns, in addition to the more traditional b+tree index format. In the method and system of the present invention, bitmap index format processing practices are improved by utilizing microprocessors having large storage units and speed, such as conventional microprocessors with multimedia application extensions. Specifically, new instruction sets and new registers are used to process bitmap index formats in larger, more efficient storage units. This method of processing can provided a significant performance improvement over more traditional methods.

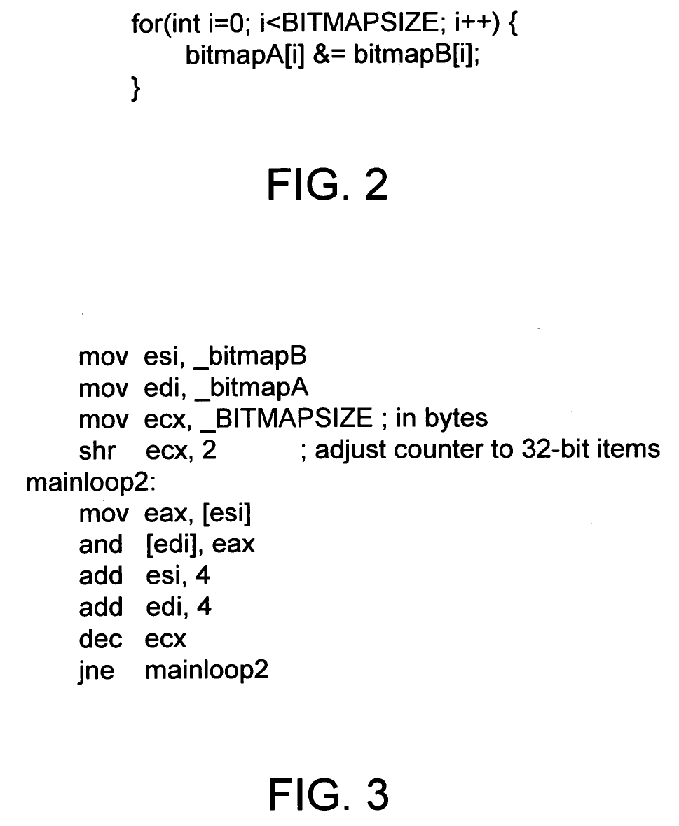

Presently, several bitmap index formats and compression schemes exist, each incurring the complicated underlying bitmap processing. The fundamental processing of the underlying bitmap index formats is a computer intensive task that uses significant computer processor and memory resources. On popular modern 32-bit CPUs, such as the Intel Pentium, the fundamental bitmap processing typically takes the form of a computer program subroutine written in C language or some other programming language. One such example is shown in FIG. 2. This typical C code can compare two bitmaps and compute the intersection, as would be done during a “join” on two bitmap indexes. This processing includes movement of data from memory to CPU registers, processing of a logical AND on the data items, then movement back to memory, in addition to some overhead for incrementing pointers and counters.

Alternatively, an assembly language programmer (or C compiler) could produce the corresponding code shown in FIG. 3

In each previous example of FIGS. 2 and 3 the critical processing is the movement of bitmaps A and B from memory to CPU registers and the use of a logical AND instruction to find the intersection of the sets. The efficiency and speed of this processing is highly dependent on the size of the storage units, and the speed at which those units can be processed. On common processors, such as Intel Pentium, these storage units can be 8-bit (byte), 16-bit (word), or 32-bit (double word). In a 32-bit processor (like the Intel Pentium), it is more efficient to process bitmaps in 32-bit storage units, rather than in 8-bit storage units, because the internal parallelism inherent in a 32-bit processor allows fewer instructions, memory accesses, and loop iterations needed to process a bitmap of given size. For example, given a 4000 byte bitmap, Intel Pentium could process an AND instruction 4000 times on 8-bit storage units, or could process the AND instruction 1000 times on 32-bit storage units. Since it takes approximately the same amount of time for each individual AND instruction, regardless of whether it processes an 8-bit or 32-bit storage unit, it is significantly faster to process the larger bitmap storage units, such as 32-bit storage units. However, processing bitmaps, even in 32-bit storage units, uses significant computer processor and memory resources. Moreover, this problem increases as the number and size of bitmaps increases.

Preferred embodiments of the present invention take advantage of the fact that, in recent years, microprocessor manufacturers have made improvements to their products in order to improve the performance of multimedia application, such as digital video, graphics, digital games, and digital music. The present invention applies these improvements to database bitmap index processing.

The newer Intel compatible CPUs (such as Intel Pentium III, Intel Pentium 4, and CPUs from AMD) contain highly specialized instructions and registers, presently designed for multimedia processing. Specifically, the Intel Pentium III or higher CPUs contain eight 128-bit registers and the additional instructions to utilize them. The preferred embodiments of the present invention include a system and improved programming method which utilize these new 128-bit registers (xmm0-xmm7) and the additional two new instructions: 1) MOVDQA, which moves 128-bit storage units to/from memory and 128-bit registers, and 2) PAND, which computes a logical AND on entire 128-bit storage units.

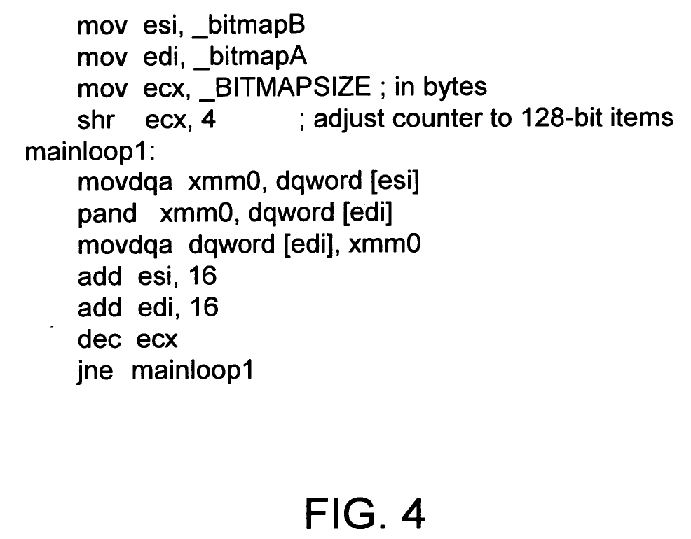

FIG. 4 illustrates the code sample which shows the use of these new registers and instructions to process bitmaps, according to the preferred embodiments of the present invention, which presently uses assembly language because the standard ANSI C language does not normally provide support for 128-bit processing. However, the present invention can be applied to any microprocessor and programming language which has instructions and registers designed for storage and simultaneous processing of at least 128 bits, which may or may not be designed for multimedia processing.

There are numerous code optimization techniques that could be applied to the code fragments shown in FIG. 4, like loop unrolling, etc. Even without these optimization techniques processing the bitmaps in 128-bit storage units, rather than in 32-bit storage units, significantly improves efficiency and speed by reducing the number of instructions, memory accesses, and loop iterations needed to process a bitmap of given size. This method is very easy to implement and can be used in conjunction with (and in addition to) other optimization methods. Recent advancements in computer processor design and instructions sets have enabled programmers to more efficiently process bitmaps in bitmap index format database structures, thus allowing better utilization of valuable computing resources and providing improved RDBMS performance.

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A computer-based method for database bitmap index processing in a database management system, the method comprising the steps of:
(a) utilizing a microprocessor supporting instructions for simultaneous processing of at least 128 bits and having storage units of at least 128 bits to process bitmap index format database structures.

2. The method according to claim 1, wherein said instructions belonging to the microprocessor's multimedia application extension.

3. The method according to claim 1, wherein said instructions being assembly language instructions, a first instruction for moving content of the entire storage unit of at least 128 bits between a memory and a register, and a second instruction for performing a logical AND instruction on the two storage units of at least 128 bits.

4. The method according to claim 1, wherein a join operation on two bitmap indexes being performed by comparing two bitmap indexes and computing their intersection using a logical AND instruction.

5. A data processing system for database bitmap index processing in a database management system, comprising means for performing the steps of:
(a) utilizing a microprocessor supporting instructions for simultaneous processing of at least 128 bits and having storage units of at least 128 bits to process bitmap index format database structures.

6. The system according to claim 5, wherein said instructions belonging to the microprocessor's multimedia application extension.

7. The system according to claim 5, wherein said instructions being assembly language instructions, a first instruction for moving content of the entire storage unit of at least 128 bits between a memory and a register, and a second instruction for performing a logical AND instruction on the two storage units of at least 128 bits.

8. The system according to claim 5, wherein a join operation on two bitmap indexes being performed by comparing two bitmap indexes and computing their intersection using a logical AND instruction.

9. A computer usable medium, in a database management system, tangibly embodying a program of instructions executable by the computer to perform a computer-based method for database bitmap index processing, comprising the steps of:
(a) utilizing a microprocessor supporting instructions for simultaneous processing of at least 128 bits and having storage units of at least 128 bits to process bitmap index format database structures.

10. The method according to claim 9, wherein said instructions belonging to the microprocessor's multimedia application extension.

11. The method according to claim 10, wherein said instructions being assembly language instructions, a first instruction for moving content of the entire storage unit of at least 128 bits between a memory and a register, and a second instruction for performing a logical AND instruction on the two storage units of at least 128 bits.

12. The method according to claim 10, wherein a join operation on two bitmap indexes being performed by comparing two bitmap indexes and computing their intersection using a logical AND instruction.
